(19) United States
(12) Patent Application Publication
(10) Pub. No.: US 2009/0112510 A1
(43) Pub. Date: Apr. 30, 2009

(54) Method and system for continuously determining vessel draft and amount of cargo in a vessel undergoing loading

(76) Inventors: John C. Crane, Baton Rouge, LA (US); Matthew R. Magnuson, Greenwell Springs, LA (US); Paul E. Morton, Baton Rouge, LA (US); Mike M. Asoodeh, Hammond, LA (US)

Correspondence Address: Niti Duggal, 2355 Drusilla Lane, Baton Rouge, LA, 70809, US

(21) Appl. No.: 11/980,953

(22) Filed: Oct. 31, 2007

(51) Int. Cl. G01B 21/18; G01G 19/00

(52) U.S. Cl. 702/166; 702/174

(57) ABSTRACT

The present invention discloses an improved method and system to continuously acquire, record, and analyze data with the goal of determining the draft of a water-borne vessel and/or the amount of cargo currently loaded.

### BACKGROUND OF THE INVENTION

1. Field of the Invention

This invention relates to loading barges and other floating vessels in general and more particularly, to an improved method and system to measure, record, and analyze data related to the draft of a water-borne vessel and/or the amount of cargo in the vessel during loading operations, with minimal involvement of personnel on the vessel.

2. Prior Art

Water-borne vessels, such as ships and barges, are commonly used to transport cargo utilizing oceans, navigable rivers, canals and lakes. Their ability to carry large amounts of cargo economically makes them particularly suitable for transporting dry bulk cargo, liquid cargo and other similar type cargo that can be loaded by clamshell buckets, conveyors or pumped into the vessel holds. However, to improve the transportation economics, as well as to be able to determine the amount of cargo that has been loaded onto the vessel, it is important to obtain accurate readings of the vessel draft. It is also important to have accurate vessel draft readings to prevent the barge from bottoming out in a waterway during the transporting of the cargo.

Particular problems exist with current barge drafting measurement techniques during loading operations. In the current system, barge drafters use modified tape measures or elongated measurement sticks during loading to obtain a freeboard height using a theoretical distance from the top of the barge to the water level at six set locations around a barge. According to the Barge Surveying Taskforce, a group of individuals put together by the Fertilizer Institute to standardize barge drafting measurements, variations among readings in a non-loading environment exceed ±3.5% and are seldom repeatable within 0.5% which can lead to a cost variation of over $10,000 per barge. In a loading environment, these readings are generally even higher due to the motion of the barge and lack of accessibility of one side of the barge due to physical hazards.

Freeboard measurements are an attempt to measure the distance from the molded deck down to the water line. Each barge generally has a published depth, which is measured from the deck of the barge to the bottom of the barge. However, during the lifetime of the barge, the decks generally become uneven due to stresses and collisions, making it difficult to find the “true” plane of the barge deck. While there are many problems with the current manual system of barge drafting, most errors can be traced back to one of four main areas. These include inaccurate integration of the measurements to the barge, failure to accurately estimate where the “true” water level due to wave activity, data entry, and computational errors resulting from the method of recording the measurements made.

Some barge drafting systems work on the assumption that the molded deck has no abnormalities. This assumption is rarely true and the error introduced can throw the calculations off by a number of inches. Other barge drafting systems take advantage of the fact that each barge generally has a series of draft numbers permanently attached to the side of the barge adjacent the four corners of a barge. Each block number has a height of exactly six inches and is calibrated from the bottom of the barge. These numbers generally are not affected by stress or collisions. In these other barge drafting systems surveyors use these numbers to establish a zero point where the “true” top of the deck should be located. The use of these numbers as a zero point allows integration into the barge dimensions regardless of the condition of the deck. In these systems surveyors drop a tape measure down to the water and estimate when the tape's end point is halfway between the peak and valley of the waves intersecting the barge. However, this is simply a visual estimate and can vary a number of inches depending on the surveyor, the visibility, sight obstructions such as adjacent barges, and wave conditions. Conditions typically produce waves in excess of one foot down to an inch in amplitude. Conditions on oceans and rivers can drastically affect the freeboard measurements when compared to readings taken within an area such as a protected port. Furthermore the exact point along the curve of the wave being measured is currently determined by the surveyor which leads to differences amongst surveyor practices. In addition, the poor visibility at the time the measurement is taken can also create problems with the measurement. This is particularly true if one is measuring vessels, such as barges, that are tied up next to one another. In such instances there may only be one inch separating the adjacent vessels which impairs the surveyor's ability to make visual observations regarding the position of the tape measure, particularly when the barge deck may be six or more feet from the water surface. Additionally, such measurements can be dangerous if the vessels are rocking due to wave action or other forces. The marine surveyor can slip and fall from the vessel, or in some cases his hand, foot or other body part can get crushed between two vessels that rock into one another.

Surveyors measure the barge drafts of the vessel where it is floating in the water. In many cases, the location of the vessel is an isolated area. The surveyors currently manually write down their freeboard values taken from their tape measure observations. These values are later used for computation and then finally for the final survey report. Thus, additional problems occur because of the double entry of the measured distances.

One attempt to obtain more accurate barge draft readings was through positioning of pressure sensors below the water surface of the barge. One such device is described in U.S. Pat. No. 5,547,327 entitled “Method and Apparatus for Continuously Determining the Inclination and Draft of a Waterborne Floating Vessel to Enable Automatic Loading of the Vessel” that issued on Aug. 20, 1996. However, this solution has not found widespread commercial acceptance. Difficulties in positioning the pressure sensors, taking accurate reading of the sensors, analyzing the sensor readings, and the potential of damage to the sensors during transportation are suspected difficulties that still leave the need for more accurate and reliable methods and apparatus to measure barge draft and the amount of cargo loaded in a barge.

Another attempt to solve these industry problems is the use of multiple ultrasonic sensors to determine the barge draft. One such device is described in U.S. Pat. No. 6,836,746 entitled “Method and Apparatus for Calculating the Payload on a Water-Borne Vessel” and issued on Dec. 28, 2004. However, this solution has also not found widespread commercial acceptance. Again difficulties in positioning such sensors and obtaining accurate readings when the vessel is rocking or measuring the draft of vessels that are closely positioned next to one another still leaves a need in the industry for better methods and apparatus to determine vessel drafts.

During the loading process, terminals attempt to load the vessel in a level manner while also loading a particular amount of cargo and its corollary draft; with the amount of cargo already loaded onto the vessel being determined by the vessel's draft at intervals during the loading process. The problems and errors in accuracy caused by manual freeboard drafting are accentuated at high speed loading terminals which typically can load to rates of more than 75 tons a minute. Currently, the industry standard involves using log measuring sticks to draft the vessel as it is loaded by deckhands walking around the outer deck of the vessel while staying away from side of the vessel adjacent to the loading structure. Deckhands are currently not able to measure the side of the barge adjacent to the loading structure, due to the dangers inherent with the load process. The side-to-side measurements are therefore eyeballed. Measurement information from the deckhand is either radioed or transmitted through hand gestures to the operator positioned above in a loading control room.

Loading terminals generally do not have the ability to unload material from a vessel. This load-only capability coupled with high loading rates, lead to high financial and time penalties for overloaded vessels. Due to the lack of accuracy involved in the loading process and the penalties involved in overloading a vessel, most vessels are under-loaded by more than six inches. This continued under-utilization of vessel capacity, leads to large amounts of dead freight. The improved loading drafting system of the present invention as described, renders continuous and accurate draft measurements during the loading process and opens the door for terminals to recapture the lost dead freight tonnage. In addition, this system provides for a more evenly distributed load while also providing additional safety for the deckhands.

Other loading drafting systems have been proposed, but they require on-vessel sensors to have visual access to the water's surface due to the fact that they either measure freeboard directly from the side of the vessel using ultrasound or lasers, or measure water pressure caused by the depth of water at the hull line. In most high speed loading facilities, barges are tied together with less than an inch of clearance between them not allowing these systems clear sensing areas. In addition, environmental factors such as the weather, and wavy waters further degrade the accuracy of bulk cargo measurements. In the system of the present invention, water level measurement is not required to be taken from the vessel, allowing the system to be used in a group of tightly packed barges, and further reducing or eliminating the affect of environmental factors.

### OBJECTS AND SUMMARY OF THE INVENTION

Therefore, one object of the invention is to provide an improved system that can easily, safely and accurately provide vessel draft information during and directly after a high speed loading terminal operation, with minimal involvement of personnel on the vessel.

Another object of this invention is to provide an improved system that can obtain draft information without regard to the adjacent distances provided between barges being loaded. Another object of this invention is to provide an improved system that minimizes environmental factors which alter repeatable accuracy.

These and other objects and objectives of the invention shall be apparent from the description of the invention contained herein.

Accordingly, the present invention provides an improved method and system for determining the draft of a vessel from an adjacent secondary fixed known location such as a stationary dock or floating loading platform. The system includes a plurality of fixed base devices stationed off the vessel in a permanent configuration, and capable of sending and receiving electronic signals; a plurality of markers placed onto the vessel in known locations, these markers being either passive or active i.e. capable of sending and receiving electronic signals; a plurality of water freeboard level monitors permanently attached to the fixed known location and in known relation to the fixed base devices, the monitors capable of sending electronic signals and configured to measure the distance of the fixed base devices from the water level; and a computer system in operative communication with the fixed base devices, the water freeboard level monitors, and the active markers, to receive data from same. By utilizing the freeboard measurements, and the known location of the base devices, and by tracking and identifying the location of the of the markers, the computer system then makes calculations based on a given computational formula to determine the draft of the vessel. The aforementioned process continues during the entire duration of the loading process, such that the computer system continuously provides real time information regarding the vessel loading process. The system of the present invention is flexible in that different types of base devices, markers, and computational formulas may be utilized to provide information regarding the vessel loading process.

### BRIEF DESCRIPTION OF THE DRAWINGS

The accompanying drawings illustrate a preferred embodiment of this invention. However, it is to be understood that these embodiments are not intended to be exhaustive, nor limiting of the invention. They are but examples of some of the forms in which the invention may be practiced.

FIG. 1 illustrates a conventional high-speed loading terminal.

FIG. 2 illustrates a preferred embodiment of the rover device of the GPS RTK based drafting system of the present invention, positioned at a desired location on the vessel.

FIG. 3 illustrates a preferred embodiment of the fixed base device and the water freeboard level monitors of the GPS RTK based drafting system of the present invention, to be mounted in a known fixed location off the vessel.

FIG. 4 is a flow diagram of a preferred embodiment of the invention, depicting the operation of the GPS RTK based drafting system of the present invention.

### PREFERRED EMBODIMENTS OF THE INVENTION

Without any intent to limit the scope of this invention, reference is made to the Figures in describing the preferred embodiments of the invention.

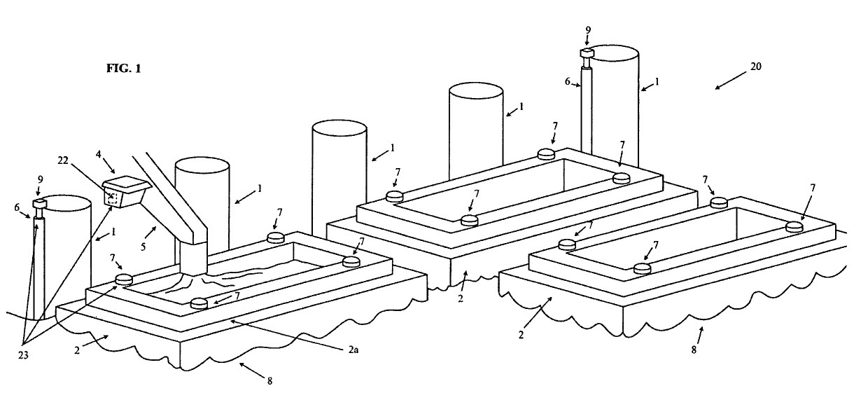

Referring now to FIG. 1, a typical high speed loading terminal 20 is depicted. Docking locations, known as cells 1, are located in the waterway, providing surfaces against which the vessels 2 can be placed. A group of vessels 2 are placed against the cells 1 and held tightly to the cells 1 with a holding line. A winch line controlled by the operator's room 4 allows the group of vessels 4 to be pulled back and forth against the cells 1 and under the feeder 5. An operator in the control room 4 may vary the speed of the feeder 5, typically a belt, and the movement of the vessel 2 under the feeder 5 using the winch cables 3 in order to properly load the vessel 2. As depicted by FIGS. 1, 2, and 3, the improved system 23 of the present invention comprises a central computer system 22, situated in the control room 4, a plurality of off-vessel fixed base devices 9, a plurality of off-vessel water freeboard level monitors 6, and a plurality of on-vessel markers 7.

In one preferred embodiment of the drafting system 23 of the present invention, Global Positioning Systems modified with Real Time Kinematic satellite navigation (GPS RTK) are utilized as the basis to measure vessel draft. RTK satellite navigation is a technique based on the use of carrier phase measurements of the GPS, GLONASS and/or Galileo signals where a single reference station provides the real-time corrections of even to a centimeter level of accuracy. Heretofore, GPS RTK technology has primarily been utilized for land survey purposes. The present invention proposes the unique integration of this GPS RTK technology into the vessel-drafting system 23.

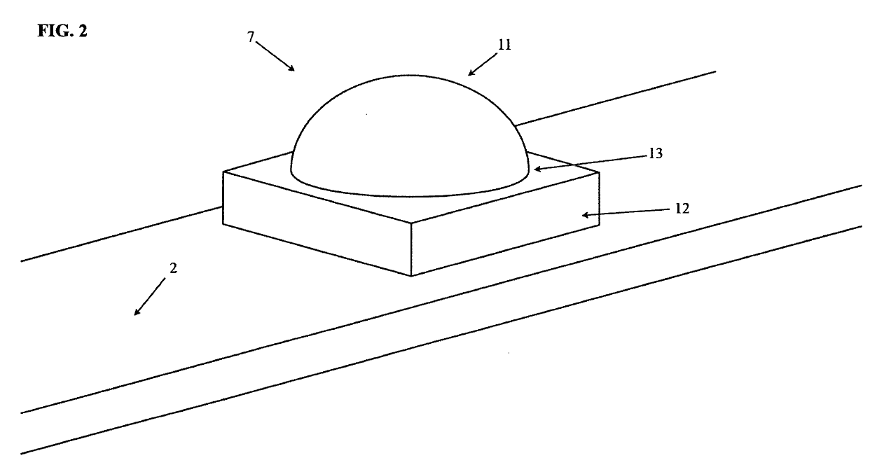

Turning first to a discussion of a preferred embodiment of the markers 7 of the system 23, each marker 7 will be a rover device 7 cable of sending and receiving electronic signals. As depicted by FIG. 2, each rover device 7 comprises a GPS antenna 11 in communication with a GPS receiver 12. Each rover device 7 will further comprise an internal power source such as a battery or battery pack to power the operation of the GPS receiver 12. The power source will be configured to be continuously activated or activated at pre-determined intervals. The rover devices 7 will be removably attached to the vessel 2 at desired positions prior to beginning the drafting process and will be removed after the vessel 2 has been drafted. In a preferred embodiment, four rover devices 7 will be strategically positioned on the four corners of the deck 2a of the vessel 2, above the waterline of the vessel 2. When positioning the rover devices 7, care should be taken that they are in alignment with the water line markers on the side of the vessel 2, and so that they do not obstruct satellite signals or interfere with loading and unloading operations. Although it is preferred that at least four rover devices 7 be placed on the vessel 2, fewer or more rover devices 7 may be utilized, without departing from the spirit or scope of the invention. The rover devices 7 being placed on the vessel 2 have no need of sensing or otherwise viewing the water's surface 8 but still make use of the vessel's integration points to obtain an elevation with a known relationship to the hull of the vessel 2. As illustrated in FIG. 2, each rover device 7 comprises an integration pole 13 for keeping the GPS antenna 11 affixed at a given height in reference to the integration points of the vessel 2. Each rover device 7 is further in operative communication with the central computer system 22 to allow communication back to the computer 22 through a transceiver for GPS coordinates i.e. an elevation above sea level of the rover device 7 as determined by the GPS signal, and a unique rover ID. In addition, the rover devices 7 will also be in operative communication with the fixed base devices 9, enabling the rover devices 7 to correct their position signals, as further discussed below.

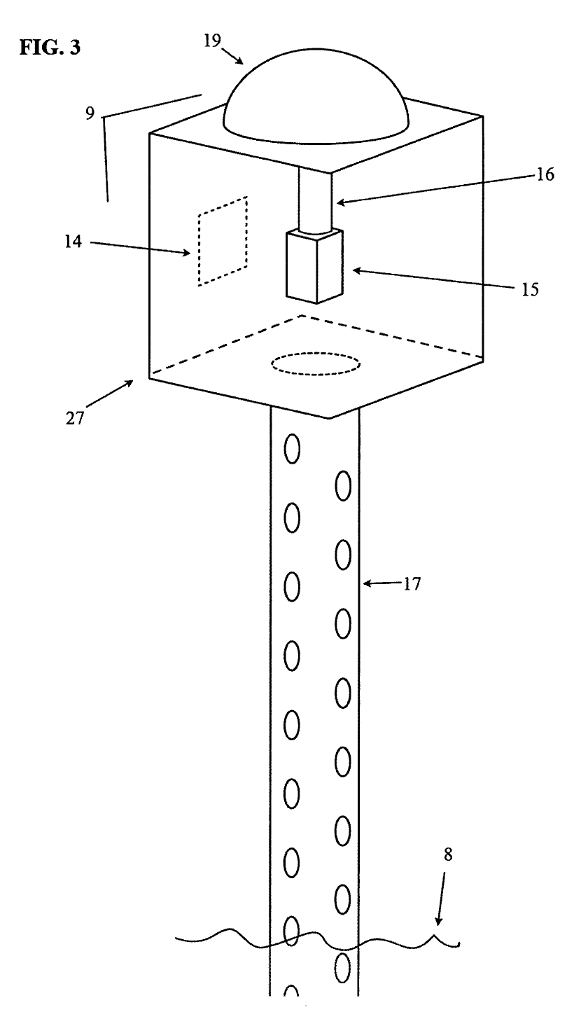

Turning now to a discussion of a preferred embodiment of the fixed base devices 9 and the water freeboard level monitors 6 of the present invention, and as depicted by FIG. 1, at least two fixed base devices 9 will be positioned at the cells 1 of the terminal 20, at known and unchanging locations in relationship to one another. Although it is preferred that at least two fixed base devices 9 be placed on the vessel 2, fewer or more fixed base devices 9 may be utilized, without departing from the spirit or scope of the invention. As further depicted by FIG. 1, attached to the fixed base devices 9 will be water freeboard level monitors 6 configured to measure and monitor the water freeboard level. In an alternative embodiment, the monitors 6 need not be attached to the fixed base devices 9, as long as they are in known proximity to same. In either embodiment, the water level measurements are not required to be taken from the vessel 2, and instead are taken from an off-vessel stationary object, allowing the improved system 23 of the present invention to be used in a group of tightly packed vessels 2, as well as reducing or eliminating the adverse affect of environmental factors, as well as the movement of the vessel, on such measurements. Each fixed base device 9 will be capable of sending and receiving electronic signals, and as depicted by FIG. 3, will comprise a GPS receiver 14 and a GPS antenna 19. Each fixed base device 9 will further comprise an internal power source such as a battery or battery pack to power the operation of the GPS receiver 19. Each fixed base device 9 is further in operative communication with the central computer system 22 to allow communication back to the computer 22 through a transceiver for GPS coordinates. As further depicted by FIG. 3, each water freeboard level monitor 6 comprises a laser or an ultrasound water level sensor 15 that is in alignment with the antenna 19 of the GPS receiver 14 via a post 16, such that the fixed base devices 9 are in known and unchanging alignment with the water freeboard level monitors 6. In a further preferred embodiment, the GPS receiver 14 and the laser or ultrasound water measurement sensor 15 is encased in a protective housing 27 that is mounted above the surface of the water 8 via a perforated post 17, in fixed perpendicular alignment with the surface of the water 8. It is to be noted that a wave smoothing code will not be needed for the water freeboard level monitors 6. Instead, the readings will be averaged over a longer period of time and the post 17 will provide natural wave elimination. The water freeboard level monitors 6, like the fixed base devices 9, are in operative communication with the central computer system 22, to thereby allow the central computer 22 to receive elevation readings from the fixed base devices 9, along with the water level offset readings from the water freeboard level monitors 6, as will be further discussed below. It is to be noted that the elevation of the fixed base device 9 is based off of a position in relation to a theoretical geoid known as GEOID96 and not based on sea level.

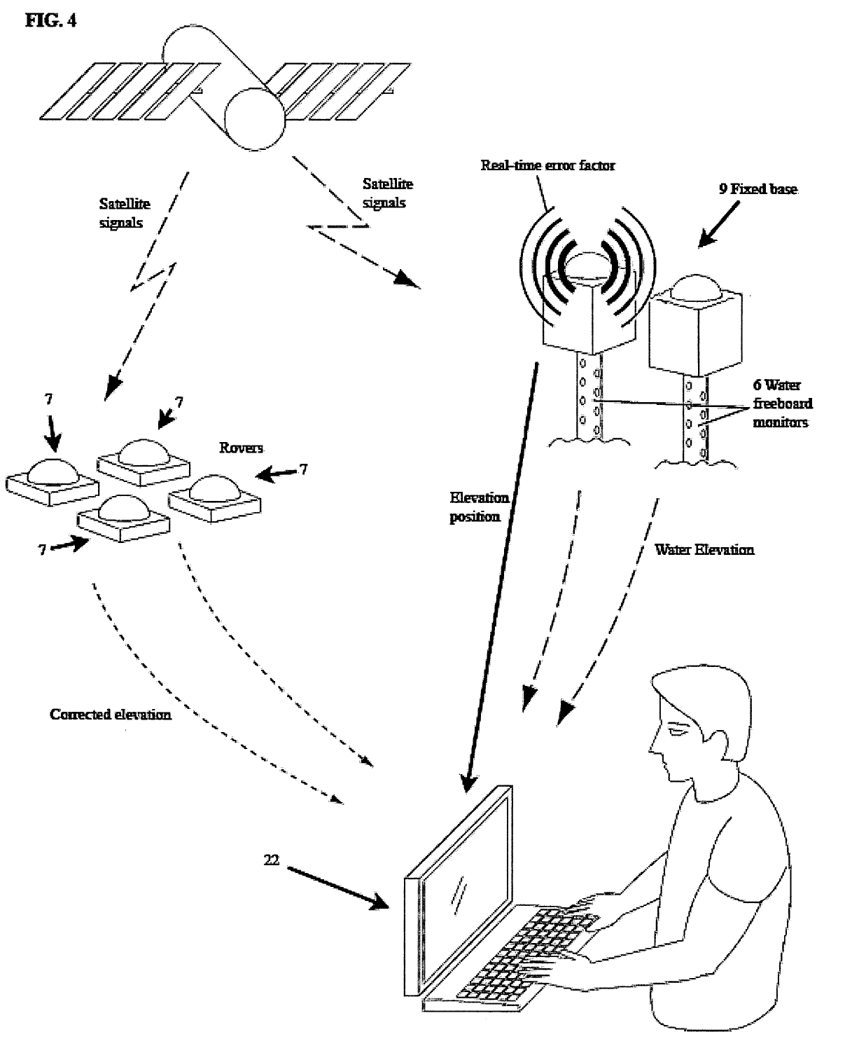

An exemplary embodiment of the operation of the improved system 23 of the present invention at a conventional loading terminal 20 will now be presented. As discussed above, the elements of the system will first be strategically positioned both on and off the vessel 2. A plurality of rover devices 7 will be removably attached to the deck 2a of the vessel 2 in predetermined positions and a plurality of fixed base devices 9 and water freeboard level monitors 6 will be permanently situated at the terminal 21 in fixed and predetermined locations, as described above. A central computer system 22 that is in operative communication with the on-vessel rover devices 7, the off-vessel fixed base devices 9, and the water freeboard level monitors 6 will be provided to the control room 4. The central computer system 22 will preferably comprise an input component to enable the operator to select the vessel to be drafted, enter target tons, draft, and other desired operational features, which can then be saved in a storage component. The central computer system 22 will further be in communication with a loading controller, such that loading will commence with a signal from the central computer system 22. During this loading process, and as depicted by FIG. 4, the fixed base devices 9 and the rover devices 7 will continuously receive satellite signals and transmit the coordinates relating to their off-vessel and on-vessel positions, respectively, to the central computer system 22. The central computer system 22 will also continuously receive signals relating to the water freeboard level, i.e. the distance of the fixed base devices 9 above the water level 8, from the water freeboard level monitors 6.

In operation, the accuracy of the elevation data produced by the on-vessel rover devices 7 can be heightened by providing both the rover devices 7 and the fixed base devices 9 with GPS receivers 9 comprising a carrier phase enhancement system such as off the shelf OEM receivers capable of Real Time Kinematic (RTK). When such a carrier phase enhancement system is provided, the off-vessel fixed base devices 9 will have the ability to use their known and unchanging position to provide the needed offset information to the rover devices 7 over a wireless link in accordance to a standard RTK or other off-the-shelf carrier phase enhancement system. Using an established algorithm, the difference between the known elevation on the base devices 9 and the elevation of the base device 9 as determined by the GPS signal is calculated. This calculated elevation difference is applied to the elevations of the rover devices 7 calculated by the GPS signal. In this manner, the on-vessel rover devices 7 will be able to correct their positional elevation and this also provides the operator with a real time error coefficient during the loading process. Furthermore, in addition to using the off-vessel fixed base devices 9 for carrier phase enhancements, the system 23 of the present invention also makes uses of differences between the known off-vessel fixed base devices 9 to determine the accuracy of the system 23 while adding redundancy to the entire system 23. By measuring the shift between the land-based devices 9 on a daily or hourly basis, an accuracy indicator can provide the operator with information relating to the accuracy of the system 23. This is needed because of the fact that the accuracy of GPS systems changes even when using carrier phase enhancements due to alterations in the ionosphere or at the discretion of the United States government. In addition, the elevation results and therefore the resulting draft measurements may further be heightened in the final report through the means of standard GPS post processing and numerical averaging of water levels after the loading has been completed.

To achieve the aforementioned accuracy, the fixed base devices 9 will be hardwired into the central computer system 22 and will each comprise radio transceivers for bi-directional communication with the on-vessel rover devices 7. The on-vessel rover devices 7 will each comprise two transceivers, one to obtain offset information from the based devices 9 and one to communicate their corrected elevation position to the central computer system 22. Any of the fixed base devices 9 will be able to provide error factor corrections, and the computer system 22 will select one of the fixed base devices 9 to be the primary correction factor transmitter. The other base devices 9 along with the rover devices 7 will then use this primary correction factor as transmitted.

Continuing with the discussion of the operation of the present system 23, once the central computer system 22 receives the corrected elevation readings from the rover devices 7, and the fixed base devices 9 as well as the water freeboard level monitors 6, the computer system 22 then compiles and processes this data. The computer system 22 subsequently generates a theoretical elevation model of the on-vessel rover devices 7, the off-vessel fixed base devices 9, and the water offset levels in the form of a point cloud via game engine. The computer system 22 then calculates the freeboard of the vessel 2 by analyzing the point cloud model and computing the theoretical position difference between the elevation of the rover devices 7 and the elevation of the water 8. The computer system 22 subsequently calculates the draft of the vessel 2 by utilizing a predetermined database of vessel hull depths, whereby the hull depth minus the calculated freeboard is the draft. The computer system 22 can also be programmed to determine the tonnage of cargo in the vessel 2, the rate of loading, and the list and trim of the vessel 2. During this continues monitoring and sensing of the draft, the computer system 22 will provide control signals to the loading controller so as to control the delivery of the material into the vessel 2. The delivery of materials is terminated when a predetermined and selected draft has been achieved.

In addition to providing the operator with numerical information relating to draft, tonnage of cargo, the rate of loading, and the list and trim of the vessel, in a further preferred embodiment, the computer system 22 will also be programmed to utilize this numerical information to generate a virtual diagram that provides a virtual loading representation with visual triggers to alert and guide the operator to his loading goal. In a preferred embodiment, the system 23 will further comprise a display component to present the graphical and numerical information to the operator in a user-friendly format. In this fashion, real time information regarding the vessel loading process is continuously provided to the operator. In addition, load instructions and loading reports can also be exchanged between the central computer system 22 and offsite computers, giving the operator access to important operational information while allowing administration to monitor loading progress. After the loading has been completed, a final draft is taken and standard GPS post-processing computation is performed on the elevation data. This information is assembled into a report and made available to administration automatically via a standard network service.

In a preferred embodiment of the invention, the following series of formulas are utilized to calculate the freeboard, draft, tonnage, and rate of loading of the vessel.

Elevation of water=(Elevation of fixed base device from theoretical GPS Geode)−(Offset to water freeboard monitors)−(distance measured to water level)

Freeboard=(Elevation of fixed base device from theoretical GPS Geode)−(Elevation of water)

Draft at measuring location=(Freeboard)−(Barge Hull Depth)

Fore/Aft mean draft “FMA”=(Fore Port+Fore Starboard+Aft Port+Aft Starboard)/4

Midship mean draft “MSM”=(Mid Port+Mid Starboard)

Mean of Mean draft “MOM”=(FAM+MSM)

Quarter mean draft “QTR”=(MOM+MSM)/2

Mean Waterline Length=(((Port waterline length light+Starboard waterline length)/2)+((Port waterline length heavy+Starboard waterline heavy)/2))/2

Displacement (cubed)=(Barge width)*Mean water length*Change in draft

Assumed density from hydrometer=DH

Lb/Cu Ft Pure Water at 1.000 density=62.43

Lb/Cu Ft of Flotation Water=DH*62.43

Pounds of Cargo=(Lb/Cu Ft of Flotation Water)*Cubic Feet of Water Displaced

Metric Tons/Min=(Pounds of cargo @ (Time−1 Minute)−Pounds of cargo at (Time))*0.00045359237

It is to be noted that the system of the present invention is flexible in that different types of base devices 9, markers 7 and computational formulas may be utilized to provide information regarding the vessel loading process. Thus far, one preferred embodiment of the system 23 has been presented, in which Global Positioning Systems modified with Real Time Kinematic satellite navigation (GPS RTK) are utilized as the basis to measure vessel draft. However, other suitable variations in the approaches to provide accurate, continuous vessel draft readings with minimal involvement of personnel on the vessel are also contemplated and will be discussed below. Whatever the variation, the basic concept of the system will include a plurality of off-vessel fixed base devices 9 capable of sending and receiving electronic signals; a plurality of active or passive markers 7 placed onto the vessel 2, a plurality of water freeboard level monitors 6 attached to the fixed base devices 9 and configured to measure and monitor water freeboard levels; and a computer system 22 in operative communication with the fixed base devices 9, the active markers 7, and the water freeboard level monitors 6 to receive data from same to compute the draft of the vessel therefrom.

In another preferred embodiment, the system 23 of the present invention will be based on a Laser Optical System (LOS). In this embodiment, the fixed base devices 9 are a series of camera/laser combinations. In a preferred embodiment, the cameras will be automated and configured to have tilt and pan capabilities. The markers 7 will be a plurality of passive reflectors of a known size, shape, and color. The reflectors will be placed on the four corners of the vessel 2. Each camera/laser combination will be matched to a particular marker. As the vessel 2 moves within the camera's view, the camera will be programmed to locate and identify the reflector and then activate the laser to measure the angle and distance of the markers 7 from the fixed base devices 9. With this optical information provided by the camera/laser combinations, in conjunction with the water freeboard readings provided by the water freeboard level monitors 6, the computer system 22 can then make calculations to determine the draft of the vessel 2.

In another preferred embodiment, the system 23 of the present invention will be based on a Point Cloud Optical Triangulation System (PCOPTS). In this embodiment, the fixed base devices 9 are high resolution cameras programmed to scan the entire area where the vessel 2 is being loaded and over a period of time, and measure changes in the vessel draft. Multiple passive reflectors of a known size, shape and color will be placed on the vessel. Multiple cameras will be used to track the markers and generate images, with these images then being used to triangulate the distance from the cameras to the known points on the vessel 2. With this optical information provided by the cameras, in conjunction with the water freeboard readings provided by the water freeboard level monitors 6, the computer system 22 can then make calculations to determine the draft of the vessel 2.

In another preferred embodiment, the system 23 of the present invention will be based on Radio Signal Strength Indicator (RSSI) Triangulation system. In this embodiment, the fixed base devices 9 are a series of radio transceivers with capabilities to send and receive radio frequency signals. The markers 7 are also radio transceivers with capabilities to send and receive radio frequency signals. The markers 7 are placed on the vessel 2 at various places and transmit and receive signals between the base devices 9. With this information, in conjunction with the water freeboard readings provided by the water freeboard level monitors 6, the strength of the signal between the devices is measured and triangulated by the computer system 22 and calculations can then be made to determine the draft of the vessel 2.

While the invention has been described in terms of its preferred embodiment, other embodiments will be apparent to those of skill in the art from a review of the foregoing. Those embodiments as well as the preferred embodiments are intended to be encompassed by the scope and spirit of the following claims.

What we claim is:

1. A system for continuously determining the draft of a waterborne floating vessel as the vessel is being loaded comprising:
a. a plurality of fixed base devices stationed off the vessel at a fixed known location, the fixed base devices configured to produce electronic signals containing positional elevation data;
b. a plurality of markers attached to the vessel, the markers configured to produce electronic signals containing positional elevation data;
c. a plurality of water freeboard level monitors in known proximity to the fixed base devices, the monitors configured to produce electronic signals relating to the measured distance of the fixed base devices from the water level;
d. a computing system configured to receive the electronic signals from the fixed base devices, the markers, and the water freeboard level monitors, to compute the draft of the vessel therefrom.

2. The system of claim 1, wherein each of the fixed base devices and each of the markers comprise a global positioning receiver including a carrier phase enhancement system.

3. The system of claim 1, wherein the fixed base devices are in operative communication with the markers, wherein each of the fixed base devices and each of the markers comprise a global positioning OEM receiver capable of real time kinematic, and wherein the fixed base devices are configured to transmit real-time corrections to the markers, wherein the markers utilize this information to correct their positional elevation data.

4. The system of claim 3, wherein the water freeboard level monitor comprises a laser water level sensor.

5. The system of claim 3, wherein the water freeboard level monitor comprises an ultrasound water level sensor.

6. The system of claim 3, wherein the plurality of fixed base devices is two, and wherein each fixed base device is attached to the cell of a vessel loading terminal.

7. The system of claim 3 wherein four markers are positioned at locations defining four corners of the vessel.

8. The system of claim 3, wherein the system is further configured to determine the shift between the fixed base devices.

9. The system of claim 1, wherein the markers are removably attached about a perimeter of the vessel at a distance above the waterline of the vessel.

10. The system of claim 1, wherein the computing system is further capable of computing additional real-time information from the electronic signals, including the tonnage of material in the vessel, the rate of loading, and the list and trim of the vessel.

11. A system for continuously determining the draft of a waterborne floating vessel as the vessel is being loaded:
a. a plurality of markers attached to the vessel;
b. a plurality of fixed base devices stationed off the vessel at a fixed known location, the fixed base devices configured to produce electronic signals containing optical data relating to the position of the markers;
c. a plurality of water freeboard level monitors in known proximity to the fixed base devices, the monitors configured to produce electronic signals relating to the distance of the fixed base devices from the water level;
d. a computing system configured to receive the electronic signals from the fixed base devices, and the water freeboard level monitors, to compute the draft of the vessel therefrom.

12. The system of claim 11, wherein the fixed base device comprises a camera and laser combination, and wherein the marker comprises a reflector of a known size, shape, and color.

13. The system of claim 12, wherein each camera and laser combination is matched to a particular marker.

14. The system of claim 11, wherein the fixed base device comprises a camera, and wherein the marker comprises a reflector of a known size, shape, and color.

15. The system of claim 14, wherein each camera is matched to a particular marker.

16. A system for continuously determining the draft of a waterborne floating vessel as the vessel is being loaded comprising:
a. a plurality of fixed base devices stationed off the vessel at a fixed known location, the fixed base devices configured to produce radio frequency signals;
b. a plurality of markers attached to the vessel, the markers configured to produce radio frequency signals;
c. a plurality of water freeboard level monitors in known proximity to the fixed base devices, the monitors configured to produce electronic signals relating to the measured distance of the fixed base devices from the water level;
d. a computing system configured to receive the signals from the fixed base devices, the markers, and the water freeboard level monitors, to compute the draft of the vessel therefrom.

17. The system of claim 16, wherein the fixed base devices and the markers comprise radio transceivers.

18. A method of continuously determining the draft of a waterborne floating vessel as the vessel is being loaded comprising the steps of:
a. attaching a plurality of fixed base devices off of the vessel at a fixed known location, the fixed base devices producing electronic signals containing positional elevation data;
b. attaching a plurality of markers to the vessel, the markers producing electronic signals containing positional elevation data;
c. providing a plurality of water freeboard level monitors in known proximity to the fixed base devices, the monitors producing electronic signals relating to the measured distance of the fixed base devices from the water level;
d. monitoring the signals and continuously determining the corresponding draft of the vessel therefrom.

19. The method of claim 18, wherein each of the fixed base devices and each of the markers comprise a global positioning receiver including a carrier phase enhancement system.

20. The method of claim 18, wherein the fixed base devices are in operative communication with the markers, wherein each of the fixed base devices and each of the markers comprise a global positioning OEM receiver capable of real time kinematic, and wherein the fixed base devices are configured to transmit real-time corrections to the markers, wherein the markers utilize this information to correct their positional elevation data.

21. The method of claim 20, wherein the plurality of fixed base devices is two, and wherein each fixed base device is attached to the cell of a vessel loading terminal.

22. The method of claim 21, wherein four markers are positioned at locations defining four corners of the vessel.

23. The method of claim 22, wherein the system is further configured to determine the shift between the fixed base devices.

24. The method of claim 23, wherein the computing system is further capable of computing additional real-time information from the electronic signals, including the tonnage of material in the vessel, the rate of loading, and the list and trim of the vessel.

25. A method of automatically loading a waterborne floating vessel with material comprising:
a. attaching a plurality of fixed base devices off of the vessel at a fixed known location, the fixed base devices producing electronic signals containing positional elevation data;
b. attaching a plurality of markers to the vessel, the markers producing electronic signals containing positional elevation data;
c. providing a plurality of water freeboard level monitors in known proximity to the fixed base devices, the monitors producing electronic signals relating to the measured distance of the fixed base devices from the water level;
d. monitoring the signals and continuously sensing the corresponding draft of the vessel therefrom;
e. delivering materials into the vessel in response to the sensing;
f. repeating steps d) and e) until the vessel has reached a selected draft;
g. terminating the delivery of the materials when the vessel has reached the selected draft.
